(19) United States
(12) Patent Application Publication
(10) Pub. No.: US 2003/0193513 A1
(43) Pub. Date: Oct. 16, 2003

(54) Display device

(76) Inventor: Toshio Miyazawa, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/407,243

(22) Filed: Apr. 7, 2003

(30) Foreign Application Priority Data
Apr. 10, 2002 (JP) 2002-107969

(51) Int. Cl. G09G 5/10

(52) U.S. Cl. 345/690

(57) ABSTRACT

The present invention enables a color display of high numerical aperture and multiple gray scales which can realize the multicoloring and area gray scales by simplifying the circuit constitution. A pair of transistors which hold video signals by bridging alternating power supply sources are also used as an output circuit to a pixel electrode and a capacitance is connected to the pixel electrode whereby the data writing state is controlled by making use of charge stored in the capacitance CB.

### BACKGROUND OF THE INVENTION

1. Field of the Invention

The present invention relates to an active matrix type display device, and more particularly to a multiple gray scale display device of a pixel memory system which exhibits high numerical aperture and high definition.

2. Description of the Related Art

As display devices for notebook type computers or display monitors which are capable of performing color display of high definition, display devices of various methods including a display device which uses a liquid crystal panel or a display device which uses electroluminescence (particularly organic EL) have been practically used or have been studied for a practical use thereof. The liquid crystal display devices are most popularly used these days. Here, as a typical example of the display device, a so-called active matrix type liquid crystal display device is explained.

In a thin film transistor (hereinafter referred to as TFT) type liquid crystal display device which constitutes a typical example of the active matrix type liquid crystal display device, using the TFT which is provided for every pixel as a switching element, a signal voltage (video signal voltage: gray scale voltage) is applied to a pixel electrode and hence, there is no crosstalk between the pixels so that the multiple gray scale display of high definition can be realized.

On the other hand, when this type of liquid crystal display device is mounted on an electronic device which uses a battery as a power source such as a portable information terminal or the like, it is necessary to reduce the power consumption incurred by display. Accordingly, so far, there have been made a large number of proposals with respect to an idea to provide a memory function to each pixel of the liquid crystal display device.

FIG. 11 is a schematic view for explaining a constitutional example of a liquid crystal panel which constitutes a low-temperature polysilicon TFT system liquid crystal display device which incorporates a static RAM (hereinafter referred to as SRAM) of 1 bit in each pixel. The liquid crystal panel is constituted by sandwiching liquid crystal between a first substrate and a second substrate which face each other in an opposed manner. In the drawing, reference symbol PNL indicates a liquid crystal panel. The liquid crystal panel PNL includees a pixel portion (display region) AR which occupies a major portion of a plane and a vertical scanning circuit GDR and a horizontal scanning circuit DDR which are arranged in a periphery of the pixel portion AR on the first substrate. Each pixel of the pixel portion AR includes an image memory (SRAM) of 1 bit. Here, although the liquid crystal panel PNL shown in FIG. 11 incorporates a digital-analogue converting circuit (DAC) of about 4 bits in the horizontal scanning circuit DDR thereof, this digital-analogue converting circuit (DAC) is not an indispensable constitution.

FIG. 12 is a circuit diagram for explaining the summary of the 1 bit SRAM image memory shown in FIG. 11. In the drawing, symbol GL indicates a gate line (scanning line), symbol DL indicates a drain line (signal line), symbol LC indicates liquid crystal, and VCOM indicates a common voltage. Reference symbol PIX indicates a pixel (unit pixel). The pixel PIX has a usual sampling function of supplying a gray scale analogue voltage of 4 bits to 6 bits from the outside to an electrode for driving liquid crystal as it is and an image memory function of temporarily storing the external 1 bit data to the SRAM and of outputting alternating voltages φp, φn corresponding to 1 bit data to the electrode for driving liquid crystal.

The selection of operation between the sampling function and the image memory function is controlled from the outside. Here, the alternating voltages φp, φn are AC signals which are in synchronism with the liquid crystal alternating voltage cycle and are alternated with polarities opposite to each other, wherein the alternating voltage φn is expressed by an inverted waveform of the alternating voltage φp. By adopting such a pixel constitution, it is possible to display 1 bit data stored in the SRAM at a standby time of a mobile telephone, for example, and hence, the power consumption necessary for writing data can be reduced.

### SUMMARY OF THE INVENTION

FIG. 13 is a circuit diagram for explaining the constitution of one pixel of the liquid crystal display device having the image memory circuit according to a proposal (U.S. patent application Ser. No. 09/880,819) which was already made by the applicant of the present application. On a first substrate, a drain line DL1 which constitutes one of a large number of drain lines DL is a line which is served for supplying video signals to a pixel, while selection signal lines HADL1 and VADL are lines for selecting the pixel to which the video signals are applied. Reference symbol VCOM indicates a common voltage which constitutes a fixed voltage and is arranged at a second substrate side in a so-called TN type liquid crystal panel. The pixel has a function of holding the video signal applied thereto until it is selected next time and is rewritten. Here, by replacing liquid crystal LC with electroluminescence elements, an electroluminescence type display device is obtained.

The fixed voltage VCOM is applied to a fixed voltage line VCOM-L. The fixed voltage VCOM is connected to electrodes formed on a second substrate which sandwiches the liquid crystal LC together with the first substrate. An alternating voltages PBP (corresponding to φp in FIG. 12) and PBN (corresponding to φn in FIG. 12) are applied to alternating voltage lines PBP-L and PBN-L.

Writing of the video signal to the pixel is performed when two NMOS transistors VADSW1 and HADSW1 assume an ON state in response to respective selection signals applied to the selection signal lines HADL1 which constitute the selection signal line HADL and the selection signal line VADL.

A first inverter is constituted such that the written video signal potential is used as an input gate (voltage node N8) potential, and electrodes or diffusion regions which form respective sources or drains of a pair of a p-type field effect transistor PLTF1 and an n-type field effect transistor NLTF1 are electrically connected thus forming an outputting portion (voltage node N9). The voltage node is simply referred to as “node” hereinafter.

A second inverter is constituted of a pair of p-type field effect transistor PLTR1 and an n-type field effect transistor NLTR1 which use the potential of the output portion (node N9) to which the electrodes or diffusion regions which form respective sources or drains of a pair of the p-type field effect transistor PLTF1 and the n-type field effect transistor NLTF1 which constitute the first inverter are electrically connected as an input gate potential.

A third inverter is constituted of a pair of p-type field effect transistor PPVS1 and an n-type field effect transistor NPVS1 which uses the potential of the output portion (node N8) to which the electrodes or diffusion regions which form respective sources or drains of a pair of the p-type field effect transistor PLTR1 and the n-type field effect transistor NLTR1 which constitute the second inverter are electrically connected as an input gate potential.

Then, the output portion (N8) of a pair of the p-type field effect transistor PLTR1 and the n-type field effect transistor NLTR1 which constitute the second inverter is simultaneously electrically connected to the input gate (node N8) of the first inverter. Inthen-type field effect transistors NLTF1 and NLTR1 which constitute the first and second inverters, the sources, the drains or the diffusion regions (node N6) which do not form the output of the inverters are connected to one (PBN) of the above-mentioned pair of alternating voltage lines.

Further, in the p-type field effect transistors PLTF1 and PLTR1 which constitute the first and second inverters, the sources, the drains or the diffusion regions (node N4) which do not form the output of the inverters are connected to the alternating voltage line PBP which makes a pair with an alternating voltage line (node N6) to which the electrode forming the source, the drain or the diffusion regions of the n-type field effect transistors of the first and second inverters which do not form the outputs of the inverters are connected.

In a pair of p-type field effect transistors PPVS1 and the n-type field effect transistor NPVS1 which constitute the third inverter, one of the electrodes (nodes N6 and N10) which constitute the respective sources or the drains or the diffusion regions (node N6), which do not form the output portion (node N10) of the inverters, is connected to either one of the alternating voltage lines (PBN) and the other is connected to the fixed voltage line VCOM.

The number of colors which can be realized by 1 bit SRAM is 2 for respective colors R, G, B and hence, the total number is 8 colors (2×2×2). However, the number of colors is too small for color display and hence, the use of the above-mentioned proposal is limited to a method for reducing power consumption for writing data by displaying 1 bit data stored in the SRAM at the above-mentioned standby time of the mobile telephone.

FIG. 14 is an explanatory view of a constitutional example of area gray scale pixels which are formed by combining the unit pixels which have been explained in conjunction with FIG. 13. In this example, areas of the pixel electrodes which constitute respective unit pixels are provided as a combination of three types of cells consisting of a cell CL-A, a cell CL-B and a cell CL-C which differ in area from each other. By selectively combining these cells which differ in area, the 3 bit 8 gray scale display is realized. By constituting the respective colors (R, G, B) using this combination, 1 color pixel which enables the multicolor display can be realized.

However, in the pixel memory method explained in conjunction with FIG. 13, the number of wiring and the number of transistors are large and the circuit scale is enlarged and hence, the reduction of power consumption is limited and, at the same time, the enhancement of the numerical aperture is difficult. Further, in the method explained in conjunction with FIG. 14, the circuit constitution and the constitution of the pixel electrode become complicated and hence, it is difficult to reduce a manufacturing cost.

Accordingly, it is an object of the present invention to provide a display device which enables the color display of high numerical aperture and multiple gray scales by succeeding in simplifying of the circuit constitution and multicoloring and by realizing area gray scales due to the simplification of pixel electrodes.

To achieve the above-mentioned object, in the present invention, the display device is configured such that a pair of CMOS transistors which hold video signals are also used as an output circuit to pixel electrodes, and a pixel electrode is connected to capacitance and a state in which data is written in a SRAM is controlled using charge stored in the capacitance. Typical constitutions of the present invention are as follows.

(1) In a display device, pixels are provided corresponding to portions where a plurality of scanning signal lines and a plurality of signal lines cross each other,

the pixels are constituted of a pixel electrode, a switching element for selecting the pixel electrode, and a storage circuit which is formed between the pixel electrode and the switching element and stores data to be written in the pixel electrode,

the storage circuit includes a pair of alternating voltage power source lines capable of applying alternating voltages which change with polarities opposite to each other,

the storage circuit has a first pair of transistors consisting of an NMOS transistor and a PMOS transistor which are connected in series by bridging the pair of alternating voltage power source lines and a second pair of transistors consisting of an NMOS transistor and a PMOS transistor which are connected in series by bridging the pair of alternating power source lines with respect to the first pair of transistors,

a common connection point of control electrodes of the first pair of transistors is connected to a series connection intermediate point of the second pair of transistors, and a common connection point of control electrodes of the second pair of transistors is connected to a series connection intermediate point of the first pair of transistors,

an output point of the switching element is connected to a connection point of the first pair of transistors,

the series connection intermediate point of the second pair of transistors is connected to the pixel electrode, and

a capacitance is connected between the common connection point of the control electrodes of the second pair of transistors and the series connection intermediate point.

(2) In the constitution (1), resistance elements are provided between the first pair of transistors and the pair of alternating voltage power source lines respectively.

(3) In the constitution (1) or (2), the pixel is constituted of a unit pixel of one color and one color pixel is constituted of the unit pixels in a plural number.

(4) In the constitution (3), a pixel electrode of each unit pixel which constitutes one color pixel is formed of a plurality of electrodes which differ in area.

(5) In the constitution (4), the plurality of electrodes correspond to a gray scale display of 2 bits or more and are selected by the switching element.

Due to the above-mentioned respective constitutions, the number of wiring and the number of transistors can be reduced and, at the same time, lowering of numerical aperture can be prevented, whereby it is possible to obtain an image display of multiple gray scales and high definition.

The present invention is not limited to the above-mentioned constitutions and the constitutions of embodiments described hereinafter and various modifications can be made without departing from the technical concept of the present invention.

### BRIEF DESCRIPTION OF THE DRAWINGS

FIG. 1 is a schematic view for explaining one embodiment of the circuit constitution of the liquid crystal panel which constitutes a liquid crystal display device as a display device of the present invention;

FIG. 2 is a circuit diagram of an image memory for 1 bit shown in FIG. 1;

FIG. 3 is an operational waveform chart showing signals or voltages applied to respective lines in FIG. 2;

FIG. 4 is a circuit diagram showing a constitutional example which makes the change of potential of a node N2 generated earlier than the change of potential of a node N1 in an image memory circuit shown in FIG. 2;

FIG. 5 is a plan view for explaining one example of a layout in a display region of one color pixel when the gray scale of color display adopts 256 color display, wherein R is 3 bit data, G is 3 bit data and B is 2 bit data;

FIG. 6 is a plan view for explaining one example of a layout in a display region of one color pixel when the gray scale of color display adopts 4096 color display, wherein R.G and B are respectively 8 bit data;

FIG. 7 is a schematic view for explaining another embodiment of the circuit constitution of a liquid crystal panel of a liquid crystal display device as a display device of the present invention;

FIG. 8 is a circuit diagram of an image memory for 1 bit in FIG. 7;

FIG. 9 is an explanatory view of a specific arrangement example of the pixel memory on a display panel according to the present invention;

FIG. 10 is a perspective view for explaining a constitutional example of a portable information terminal as an example of an electronic equipment on which the display device according to the present invention is mounted;

FIG. 11 is a schematic view for explaining a constitutional example of a liquid crystal panel which constitutes a law-temperature polysilicon TFT type liquid crystal display device which incorporates a static LAM of 1 bit in each pixel;

FIG. 12 is a circuit diagram for explaining the summary of a 1 bit SRAM image memory in FIG. 11;

FIG. 13 is a circuit diagram for explaining the constitution of 1 pixel of a liquid crystal display device having an image memory circuit according to a proposal which has been already filed by the applicant of the present application; and

FIG. 14 is an explanatory view of a constitutional example of an area gray scale pixel which is formed by combining unit pixels explained in conjunction with FIG. 13.

### DESCRIPTION OF THE PREFERRED EMBODIMENTS

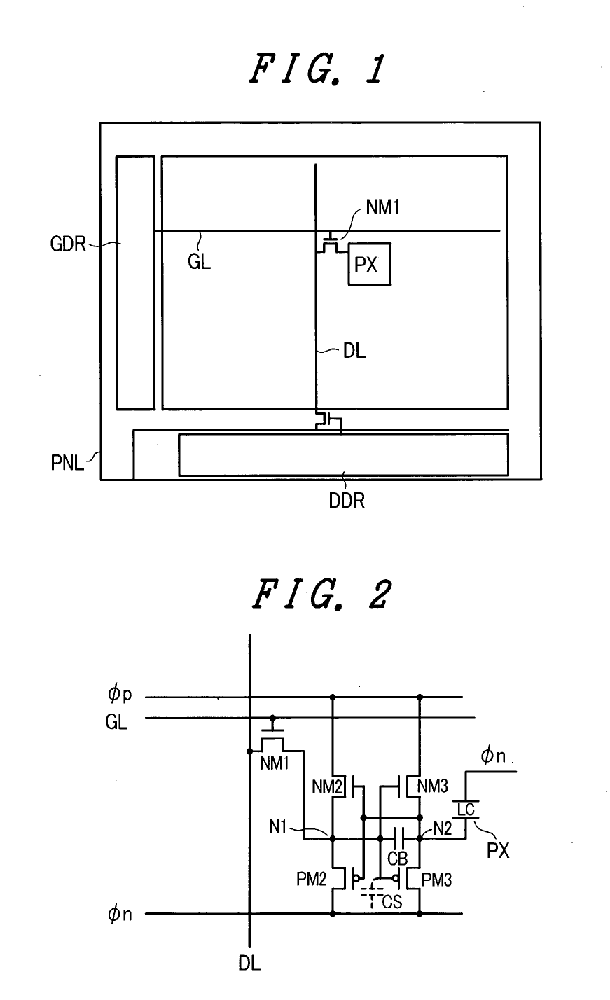

Preferred embodiments of a display device according to the present invention are explained in detail hereinafter in conjunction with drawings which describe respective embodiments. FIG. 1 is a schematic view for explaining one embodiment of the circuit constitution of a liquid crystal panel which constitutes a liquid crystal display device as a display device of the present invention. In the drawing, reference symbol PNL indicates a TFT panel, wherein on a first substrate thereof, a vertical scanning circuit GDR and a horizontal scanning circuit DDR are arranged in a periphery of a pixel portion (display region) AR which occupies a major portion of a plane. Common electrodes are arranged on a second substrate.

In FIG. 1, with respect to drain lines DL which constitute video signal lines and gate lines GL which constitute scanning lines, only one drain line DL and only one gate line GL are indicated for the sake of brevity of the explanation. In an actual liquid crystal display device, 8 pieces (256 colors), 12 pieces (4096 colors) or the like of the drain lines DL are provided corresponding to the number of pixels and these drain lines DL are sequentially connected to the gate lines GL which are extended from the vertical scanning circuit GDR. Video signals (data signals) which are supplied from the drain lines DL are written in the pixels PX in response to the selection of the gate lines GL extended from the horizontal scanning circuit DDR. Here,the pixel PX indicates a unit pixel. When the color display of 3 colors consisting of R, G and B is performed, 1 color pixel is constituted of 3 unit pixels.

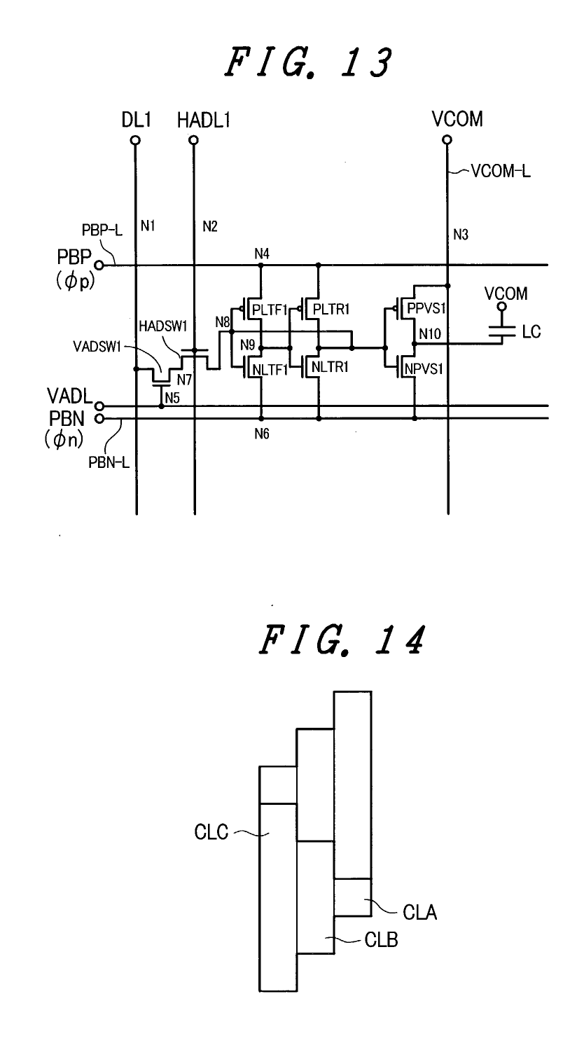

FIG. 2 is a circuit diagram of an image memory for 1 bit in FIG. 1. Although the basic operation is substantially as same as the operation explained in conjunction with FIG. 13, this embodiment differs from the example shown in FIG. 13 with respect to a point that a pair of CMOS transistors for holding data also function as an output circuit to the pixel electrode PX. The image memory (storage circuit) has a first pair of transistors consisting of an NMOS transistor NM2 and a PMOS transistor PM2 which are connected in series by bridging a pair of power source lines φp, φn and a second pair of transistors consisting of an NMOS transistor NM3 and a PMOS transistor PM3 which are connected in series by bridging the pair of power source lines φp, φn with respect to the first pair of transistors.

Alternating voltages which change with polarities opposite to each other are supplied to a pair of power source lines φp, φn. A common connection point of control electrodes of the NMOS transistor NM2 and the PMOS transistor PM2 which constitute the first pair of transistors of the memory circuit is connected to a series connection intermediate point (node) N2 of the NMOS transistor NM3 and PMOS transistor PM3 which constitute the second pair of transistors. Further, a common connection point of control electrodes of the NMOS transistor NM3 and the PMOS transistor PM3 which constitute the second pair of transistors is connected to a series connection intermediate point (node) N1 of the NMOS transistor NM2 and PMOS transistor PM2 which constitute the first pair of transistors.

Reference symbol NM1 indicates a switching element (transistor). This switching element NM1 is selected by the gate line GL and supplies video signals (data) supplied from the drain line DL to the node N1 of the NMOS transistor NM2 and the PMOS transistor PM2 which constitute the first pair of transistors. An output point of the switching element NM1 is the node N1 of the NMOS transistor NM2 and the PMOS transistor PM2 which constitute the first pair of transistors, while the node N2 of the NMOS transistor NM3 and the PMOS transistor PM3 which constitute the second pair of transistors is connected to the pixel electrode of the unit pixel PX. Then, a bootstrap capacitance CB is inserted between the node N2 of the NMOS transistor NM3 and the PMOS transistor PM3 which constitute the second pair of transistors and the common connection point of the control electrodes. Here, reference symbol CS indicates a floating capacitance.

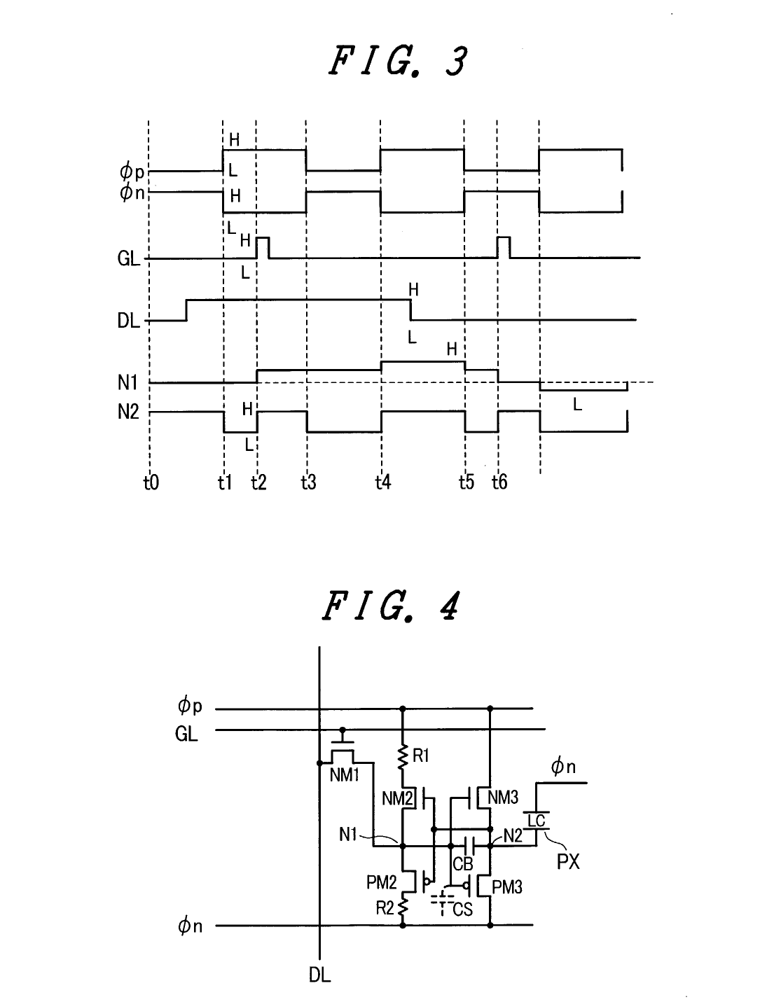

FIG. 3 is an operational waveform chart showing signals or voltages applied to respective lines in FIG. 2. In the drawing, φp, φn, GL, DL, N1, N2 respectively correspond to the signals or voltages applied to points which are indicated by the same reference symbols in FIG. 2. φp, φn are alternating voltages for driving liquid crystal and have phases opposite to each other, wherein the alternating voltage φp, φn repeat High H and Low L in a so-called 1 frame period.

Assume a case in which a state of the image memory at a point of time t0 in FIG. 3, that is, the node N1 is low. In the circuit shown in FIG. 2, since the node N1 is Low, the transistor PM3 which is a p-type TFT assumes the ON state and hence, the node N2 is connected to the alternating voltage φn. Accordingly, the potential state of the node N2 at the point of time t0 is high. Since the node N2 is high, transistor NM2 which is the n-type TFT also assumes the ON state andhence, node N1 is connected to the alternating voltage φp and the node N1 assumes the Low state which is the rewritable state.

At a point of time t1, the pair of alternating voltages φp, φn reverse the potential states thereof. When it is designed that the potential change of the node N2 is generated earlier than the potential change of the node N1, since the node N2 is connected to the alternating voltage φn through the transistor PM3, the potential of the node N2 follows the change of potential of the alternating voltage φn and is changed from the High state to the Low state. This change of the potential of the node N2 from the High state to the Low state is transmitted to the node N1 through the bootstrap capacitance CB so that the voltage of the node N1 is lowered momentarily (that is, until the node N1 is rewritten) by ΔV=(V_{High}−V_{Low})×(CB/(CB+CS)). Here, CS indicates a capacitance of the node N1 other than the bootstrap capacitance CB.

By designing this ΔV such that ΔV assumes a value larger than a threshold value voltage Vₜₕ(PM3) of the transistor PM3(absolute value of ΔV≧absolute value of Vₜₕ(PM3)), it is possible to make the node N2 assume the potential equal to the Low potential of the alternating voltage φn, while ignoring an effect of the threshold value voltage of the transistor PM3. Along with the change of the node N2 to the Low state, the transistor PM3 assumes the OFF state and the transistor PM2 assumes the ON state. Accordingly, the node N1 is connected to the alternating voltage φn through the transistor PM2 and the node N1 assumes the Low state, that is, the rewritable state.

When the gate line GL assumes the High state and transistor NM1 assumes the ON state at a point of time t2, the data of the High state of the drain line DL is written in the node N1. When it is designed that the potential change of the node N2 is generated earlier than the potential change of the node N1, that is, when it is designed that the connection between the alternating voltages φp, φn and the node N1 is weak (high resistance connection), it is possible to control the state of the node N1 at the state of the drain line DL during the gate line GL is in the High state so that the node N1 assumes the High state.

Due to such a constitution, the transistor PM3 is changed from the ON state to the OFF state and the transistor NM3 is changed from the OFF state to the ON state, while the node N2 is connected to the alternating voltage φp and is changed to the High state of the alternating voltage φp. Corresponding to such a change, the transistor PM2 assumes the OFF state and the transistor NM2 assumes the ON state and hence, the node N1 is connected to the alternating voltage φp through the transistor NM2. This provides a state in which the High state of input is held.

At a point of time t3, the pair of alternating voltages φp, φn again reverse the potential states thereof. Since the node N2 is connected to the alternating voltage φp through the transistor NM3, the potential of the node N2 follows the change of potential of the alternating voltage φp and is changed from the High state to the Low state. This change of the potential of the node N2 from the High state to the Low state is transmitted to the node N1 through the bootstrap capacitance CB and the voltage of the node N1 is lowered momentarily (until the node N1 is rewritten) by ΔV=(V_{High}−V_{Low})×(CB/(CB+CS)). Here, CS indicates a capacitance of the node N1 other than the bootstrap capacitance CB.

Since the transistor NM3 is in the discharge mode, when the relationship High (φp)−ΔV≧Vₜₕ(NM3) is satisfied, it is possible to lower the node N2 to the Low state of the alternating voltage φp. Along with the change of the node N2 to the Low state, the transistor NM2 assumes the OFF state and the transistor PM2 assumes the ON state. The node N1 is connected to the alternating voltage φn through the transistor PM2. This implies that the node N1 assumes the rewritable state in which the input assumes the High state and the memory state is held.

At a point of time t4, the pair of alternating voltages (power sources) φp, φn again reverse the potential states thereof. Since the node N2 is connected to the alternating voltage φp through the transistor NM3, the potential of the node N2 follows the change of potential of the alternating voltage φp and is changed from the Low state to the High state. This change of the potential of the node N2 from the Low state to the High state is transmitted to the node N1 through the bootstrap capacitance CB and the voltage of the node N1 is raised momentarily (until the node N1 is rewritten) byΔV=(V_{High}−V_{Low})×(CB/(CB+CS)). Here, CS indicates a capacitance of the node N1 other than the bootstrap capacitance CB.

By designing this ΔV such that ΔV assumes a value larger than a threshold value voltage Vₜₕ(PM3) of the transistor PM3(absolute value of ΔV≧absolute value of Vₜₕ(PM3)), it is possible to make the node N2 assume the potential equal to the High potential of the alternating voltage φp, while ignoring an effect of the threshold value voltage of the transistor PM3. Along with the change of the node N2 to the High state, the transistor PM2 assumes the OFF state and the transistor PM2 assumes the ON state. Due to such a constitution, the node N1 makes the transistor PM2 assume the OFF state and the transistor NM2 assume the ON state. Accordingly, the node N1 is connected to the alternating voltage φp through the transistor NM2 and the node N1 assumes the High state, that is, the rewritable state.

At a point of time t5, an operation equal to the operation which is performed at the point of time t3 is performed. At a point of time t6, the voltage applied from the gate line assumes the High state and when the transistor NM1 assumes the ON state so that Low state of the drain line at this point of time is written in the node N1. In the same manner as the above-mentioned operation at the point of time t3, in this case, the node N1 assumes the Low state and the transistor PM3 assumes the ON state so that the node N2 is connected to the alternating voltage φn. Since the alternating voltage φn is in the High state at this point of time, the transistor NM3 assumes the ON state and the memory holding setting is changed to Low holding setting. Thereafter, the operations at the above-mentioned points of time t0 to t6 and the combination of these operations are repeated.

From the above-mentioned operation, it is understood that the node N1 repeats the connection and the disconnection with the alternating power source lines so as to hold the input state, while the node N2 is connected to either the alternating voltage φp or φn in accordance with the condition of the node N1. Here, it is understood that when the node N2 is connected to one of the liquid crystal driving electrodes (pixel electrode) and another driving voltage (common electrode) is connected to the alternating voltage φn, the operation is performed such that the alternating voltage of High state and Low state can be applied to the liquid crystal LC when the node N1 is in the High state and the voltage applied to the liquid crystal LC is set to 0 when the node N1 is in the Low state.

As has been explained in conjunction with the above-mentioned operation at the point of time t1, it is a crucial requirement for the circuit constitution of this embodiment that the circuit is designed such that potential change of the node N2 takes place earlier than the potential change of the node N1. Although many techniques are conceivable to realize the design, one example is explained hereinafter.

FIG. 4 is a circuit diagram of the constitutional example to make the potential change of the node N2 take place earlier than the potential change of the node N1 in the circuit of the image memory shown in FIG. 2. In this circuit, between the transistor NM2 which constitutes one of the first pair of transistors and the alternating power source line of the alternating voltage φp and between the transistor PM2 which constitutes another of the first pair of transistors and the alternating power source line of the alternating voltage φn, resistances R1, R2 are inserted respectively.

The transistors NM2, PM2 which constitute feedback circuit elements to the node N1 are served for compensating the fluctuation of data potential of the node N1 attributed to leaking or the like and hence, the connection between these transistors NM2, PM2 and the alternating power source lines of the alternating voltage φp, φn may be set to a state having a large time constant, that is, the high resistance connection. Accordingly, to realize the above-mentioned requirement, as shown in FIG. 4, the resistances R1, R2 may be simply connected in series with the first pair of transistors. These resistances can be easily formed by controlling an opening pattern of an exposure mask used in the manufacture of this circuit (pattern for forming connection patterns of the alternating power source lines φp, φn and the transistors NM2, PM2). Further, it is possible to substitute the above constitution by increasing the ON resistance of the transistors NM2, PM2 in place of using the resistances. Diodes may be arranged in place of the resistances.

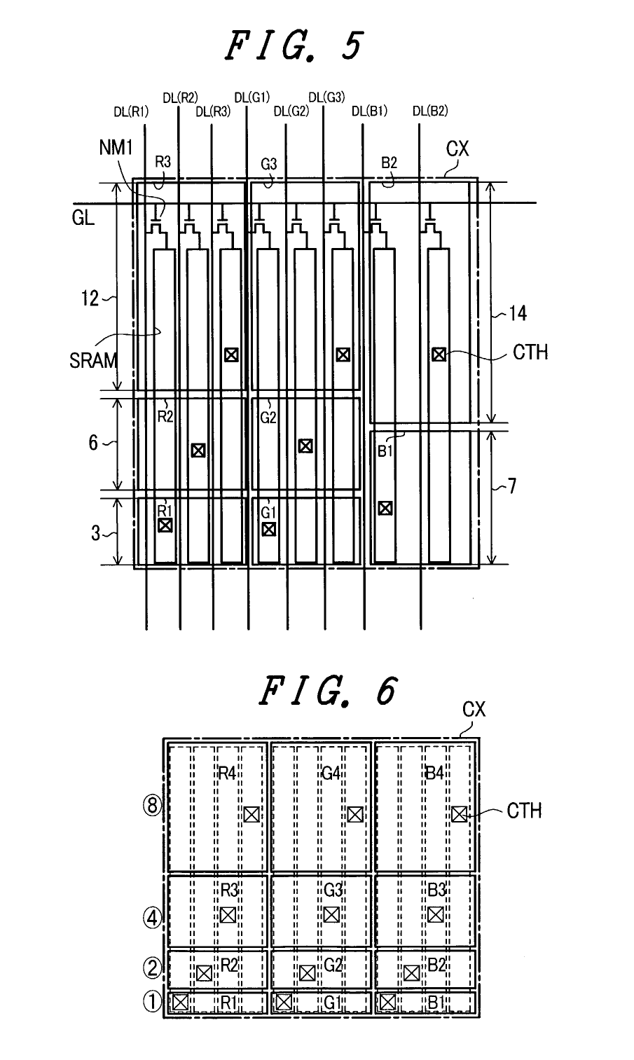

Subsequently, a layout of the multicolor pixel using the unit pixels of the present invention is explained. FIG. 5 is a plan view for explaining one example of a layout in a display region of one color pixel when the gray scale of color display adopts display of 256 colors where R is 3 bit data, G is 3 bit data and B is 2 bit data. In the drawing, reference symbol CX indicates one pixel color and R1, R2, R3 and G1, G2, G3 indicate divided unit pixel electrodes of red(R) and green(G) which are controlled by area gray scales corresponding to respective 3 bit data and B1, B2 indicate divided unit pixel electrodes of blue(B) which are controlled by area gray scales corresponding to respective 2 bit data. The unit pixel of R is constituted of the divided unit pixel electrodes R1, R2 and R3, the unit pixel of G is constituted of the divided unit pixel electrodes G1, G2 and G3, and the unit pixel of B is constituted of the divided unit pixel electrodes B1 and B2. The divided unit pixel electrodes are the above-mentioned liquid crystal driving electrodes.

The respective unit pixels of R and G are selected by the switching elements NM1 which are respectively connected to the gate line GL, three drain lines DL(R1), (R2), (R3) and three drain lines DL(G1), (G2), (G3) which supply 3 bit data. Each unit pixel includes image memories SRAM in number which corresponds to the bit number controlled by respective switching elements NM1 and outputs of the image memories SRAM are, as shown in FIG. 5, electrically connected to the divided unit pixel electrodes through contact holes CTH.

Respective unit pixels of R, G and B have the same size in the extension direction of the gate line GL, and each unit pixels R, G is divided into the divided unit pixels at a rate of “3”, “6” and “12” in the extension direction of the drain line DL, while the unit pixel B is divided into the divided unit pixels at a rate of “7” and “14”. Due to this division, the area gray scales of 256 color are realized.

With the provision of the color pixel having the layout shown in FIG. 5, the color display of 256 colors can be realized using the 8 bit data in total consisting of R: 3 bit data, G: 3 bit data and B: 2 bit data, while display data which has no change are displayed using data stored in the memory so that data transfer for every frame is unnecessary whereby the power consumption can be reduced.

FIG. 6 is a plan view for explaining one example of a layout in a display region of one color pixel when the gray scale of color display adopts display of 4096 colors where R is 8 bit data, G is 8 bit data and B is 8 bit data. In the drawing, equal reference symbols in the above-mentioned respective drawings correspond to parts having identical functions. In FIG. 6, the image memory SRAM, the switching elements, the drain line, the gate line and the like are omitted.

Then, respective divided unit pixels R1 to R4, G1 to G4 and B1 to B4 are controlled, as indicated by (1), (2), (4), (8) in the drawing, by the switching elements which are turned on or off corresponding to the respective bit data. The color display of 4096 colors can be realized using this layout, while display data which has no change are displayed using data stored in the memory so that data transfer for every frame is unnecessary whereby the power consumption can be reduced.

As described above, by making the pixels per se have the data holding function (data memory function), it is unnecessary to feed data to pixels for every frame and it is sufficient to rewrite only changed portions of data. Further, by providing the memory function to each pixel, it is possible to perform the display by reading the pixels of the display region in a random manner. The random access display can be performed by providing a random access circuit described hereinafter.

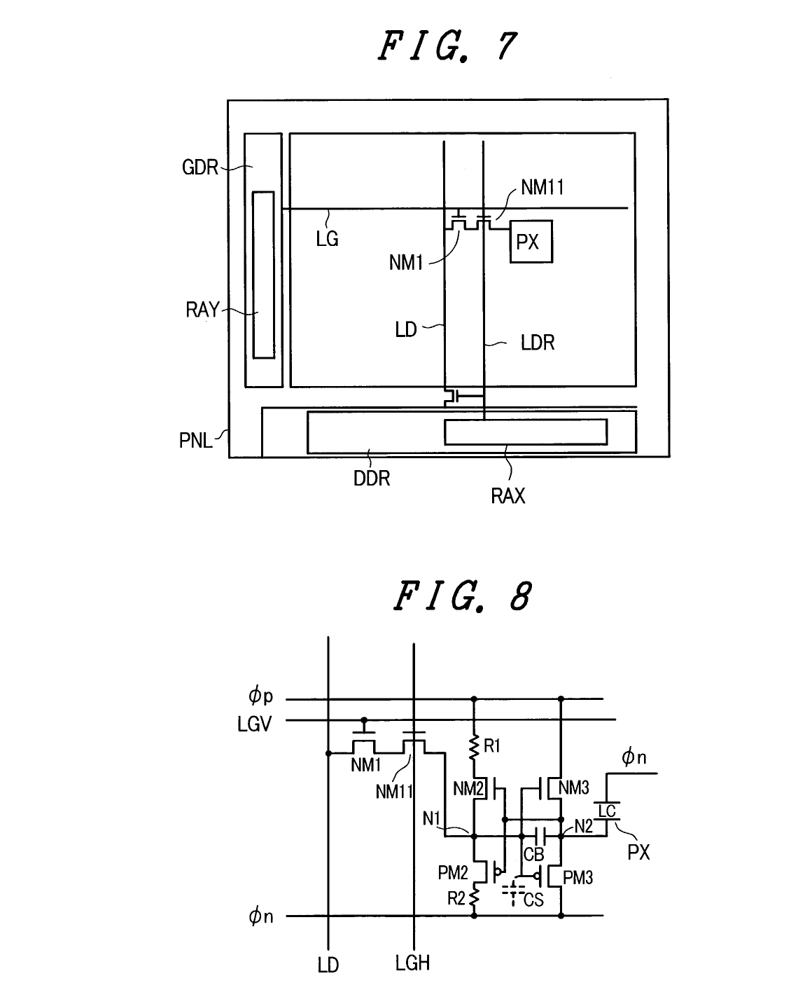

FIG. 7 is a schematic view for explaining another embodiment of the circuit constitution of the liquid crystal panel which constitutes the liquid crystal display device as the display device of the present invention. Further, FIG. 8 is a circuit diagram of an image memory for 1 bit in FIG. 7. In FIG. 7 and FIG. 8, reference symbols equal to those in FIG. 1 and FIG. 2 correspond to parts having identical functions, while RAX indicates a horizontal random access circuit, RAY indicates a vertical random access circuit, and NM11 indicates a horizontal selection transistor. This embodiment is characterized by adding the horizontal random access circuit RAX and the vertical random access circuit RAY to the horizontal scanning circuit DDR and the vertical scanning circuit GDR shown in FIG. 1 respectively and further by adding the horizontal selection transistor NM11 to the output point of the switching element NM1.

Due to such a constitution, it is possible to realize both of the display mode based on the usual sequential scanning explained in conjunction with FIG. 1 and the display mode based on the random access. Further, although the horizontal random access circuit RAX and the vertical random access circuit RAY are respectively added to the horizontal scanning circuit DDR and the vertical scanning circuit GDR in this embodiment, it is needless to say that it is possible to use only the horizontal random access circuit RAX and the vertical random access circuit RAY in place of the horizontal scanning circuit DDR and the vertical scanning circuit GDR.

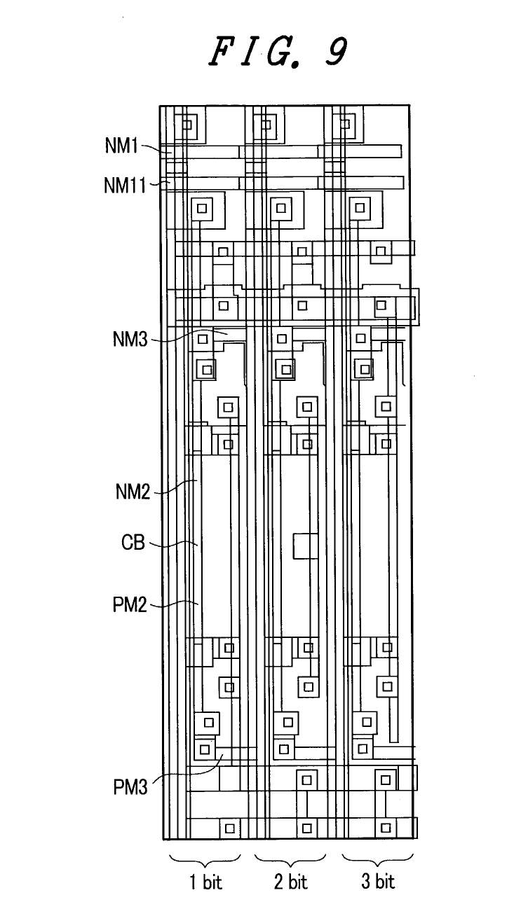

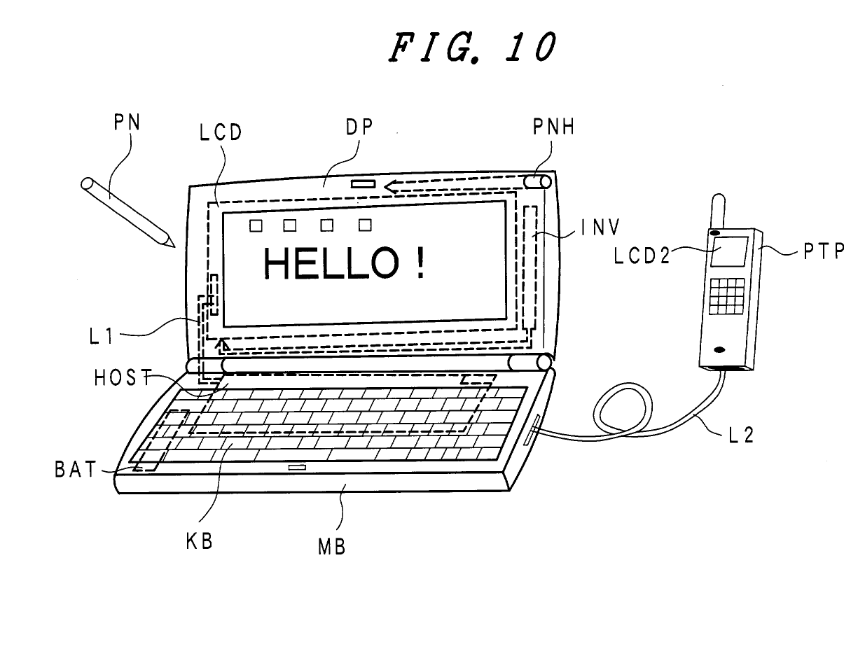

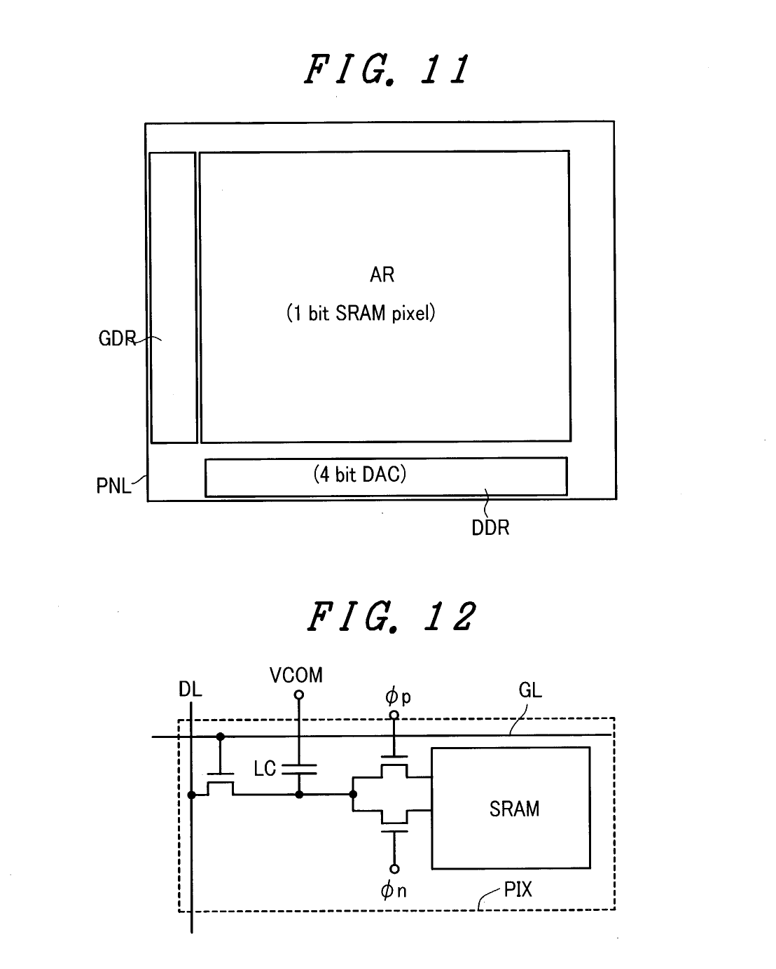

FIG. 9 is an explanatory view of an example of specific arrangement on the display panel of the pixel memory according to the present invention. That is, this arrangement includes the horizontal selection transistor NM11 which enables the random access display mode explained in conjunction with FIG. 7 and FIG. 8 and is formed by taking the 3 bit memory explained in conjunction with FIG. 5. Reference symbols in the drawing which are equal to those reference symbols in the previous embodiments indicate parts having identical functions. The lateral direction in FIG. 9 coincides with the extension direction of the gate line and the vertical direction in FIG. 9 coincides with the extension direction of the drain line. FIG. 9 shows the arrangement of respective transistors NM1, NM11, NM2, NM3, PM2, PM3 and the bootstrap capacitance CB formed on the display panel.

FIG. 10 is a perspective view for explaining a constitutional example of a portable information terminal as an example of an electronic equipment on which the display device of the present invention is mounted. This portable information terminal (PDA) houses a host computer HOST and a battery BAT and is constituted of a body part MB which is provided with a keyboard KB on a surface thereof and a display part DP which uses a liquid crystal display device LCD as the display device and mounts an inverter INV for backlight therein. The portable information terminal is configured such that a mobile telephone PTP can be connected to the body part MB by way of a connection cable L2 thus enabling communication with a remote place.

The liquid crystal display device LCD of the display part DP is connected with the host computer HOST by way of an interface cable L1. Since the liquid crystal display device LCD has the image storage function, with respect to data which the host computer HOST transmits to the display device LCD, it is sufficient to transmit only a portion of the data which differs from the data used in the previous display frame, and it is unnecessary to transmit the data when there is no change in the display whereby a burden imposed on the host computer HOST can be extremely lightened. Accordingly, an image processing device using the display device of the present invention can exhibit the low power consumption, can miniaturize the device, and can realize the high-speed processing and multi-functioning.

Here, a pen holder PNH is mounted on a portion of the display part DP of the portable information terminal and an input pen PN is housed in the pen holder PNH. Accordingly, by inputting various information using the key board KB or by applying a pushing manipulation to a surface of a touch panel or by tracing the surface of the touch panel or by writing letters to the surface of the touch panel with the input pen PN, the liquid crystal display device can perform inputting of various information, selection of information displayed on a liquid crystal display element PNL, selection of processing function and other various manipulations.

Here, the shape and the structure of the portable information terminal (PDA) of this type are not limited to those shown in the drawings and portable information terminals which have various shapes, structures and function are conceivable. Further, by adopting the display device of the present invention as a display device LCD2 used in a display part of the portable telephone PTP shown in FIG. 10, a quantity of information of display data transmitted to the display element LCD2 can be reduced and hence, image data which are transmitted through radio waves or communication lines can be reduced, and it is possible to perform display of characters, devices and photos with high gray scales and high definition on a display portion of the mobile telephone. Further, it is also possible to perform animated image display.

Further, it is needless to say that the display device of the present invention is applicable not only to the portable information terminal and the portable telephone explained in conjunction with FIG. 10 but also to a desktop type personal computer, a notebook type personal computer, a projection type liquid crystal display device and a monitoring equipment of other information terminal.

Further, the display device of the present invention is not limited to the liquid crystal display device and is also applicable to any type of matrix type display device such as the organic EL display device, the plasma display or the like.

As has been described heretofore, according to the present invention, the simplification of the circuit constitution and multicoloring can be easily performed and, further, the area gray scale can be realized by simplifying the pixel electrode whereby it is possible to provide the display device which can realize the color display of the multiple gray scales by exhibiting high numerical aperture and using least number of wiring.

1. A display device including a plurality of scanning lines and a plurality of signal lines which are arranged to cross the plurality of scanning lines and forming each pixel corresponding to a region surrounded by the plurality of scanning lines and the plurality of signal lines, wherein
the pixel is included a pixel electrode, a switching element for selecting the pixel electrode, and a storage circuit which is formed between the pixel electrode and the switching element and stores data to be written in the pixel electrode,
the storage circuit is configured such that a pair of alternating voltage power source lines capable of applying alternating voltages which change with polarities opposite to each other are connected to the storage circuit and the storage circuit has a first pair of transistors consisting of an NMOS transistor and a PMOS transistor which are connected in series by bridging the pair of alternating voltage power source lines and a second pair of transistors including an NMOS transistor and a PMOS transistor which are connected in series by bridging the pair of alternating voltage power source lines with respect to the first pair of transistors,
a common connection point of control electrodes of the first pair of transistors is connected to a series connection intermediate point of the second pair of transistors, and a common connection point of control electrodes of the second pair of transistors is connected to a series connection intermediate point of the first pair of transistors,
an output point of the switching element is connected to a connection point of the first pair of transistors,
the series connection intermediate point of the second pair of transistors is connected to the pixel electrode, and
a capacitance is connected between the common connection point of the control electrodes of the second pair of transistors and the series connection intermediate point.

2. A display device according to claim 1, wherein resistance elements are provided between the first pair of transistors and the pair of alternating voltage power source lines respectively.

3. A display device according to claim 1, wherein the pixel is constituted of a unit pixel of one color and one color pixel is constituted of the unit pixels in a plural number.

4. A display device according to claim 3, wherein a pixel electrode of each unit pixel which constitutes one color pixel is formed of a plurality of electrodes which differ in area.

5. A display device according to claim 4, where in the plurality of electrodes correspond to a gray scale display of 2 bits or more and are selected by the switching element.

6. A display device including a plurality of scanning lines and a plurality of signal lines which are arranged to cross the plurality of scanning lines and forming each pixel corresponding to a region surrounded by the plurality of scanning lines and the plurality of signal lines, wherein
the pixel includes a switching element which is arranged corresponding to each crossing point of the scanning line and the signal line and a pixel electrode,
a circuit which holds video signals from the signal line and outputs the holding video signals to the pixel electrode is arranged between the switching element and the pixel electrode, and
a capacitance is connected to the pixel electrode so as to control a writing state into a SRAM in the inside of the pixel based on charge stored in a capacity.

7. A display device according to claim 6, wherein the circuit is constituted of a pair of CMOS transistors.
